(19) United States
(12) Patent Application Publication
(10) Pub. No.: US 2003/0204639 A1
(43) Pub. Date: Oct. 30, 2003

(54) Task dispatch in priority pre-emptive real-time operating systems

(76) Inventors: David Lake, Malton (GB); Nicholas Merriam, York (GB)

Correspondence Address: SHERIDAN ROSS PC, 1560 BROADWAY, SUITE 1200, DENVER, CO, 80202

(21) Appl. No.: 10/146,239

(22) Filed: May 14, 2002

(30) Foreign Application Priority Data
Apr. 30, 2002 (GB) 0209800.2

(51) Int. Cl. G06F 9/00

(52) U.S. Cl. 709/310

(57) ABSTRACT

A method, computing device, operating system and configuration tool for optimizing or at least improving task dispatch in a priority pre-emptive real-time context are disclosed. Tasks making up an operating system are categorized into various classes in accordance with various task attributes, such as need to save floating point context, need to save digital signal processor context and the like. Each class contains only tasks having a unique combination of attributes. An individual subdispatcher function is then generated for each class, the subdispatcher function being adapted to handle tasks within that class with high efficiency. In this way, unnecessary saving and loading of contexts is reduced, and operating efficiency is improved.

The present invention relates to optimization or at least improvement (in time and space domains) of task dispatch in priority pre-emptive real-time operating systems that consist of a plurality of different types of tasks. Embodiments of the present invention are of particular relevance to the technical field of embedded devices and the control thereof, since these generally use static priority-based scheduling given the limited range of functions required.

In an operating system that is based around static priority based task scheduling (systems in which the priority ordering of the tasks is determined offline and remains constant), there exists some external description of the tasking structure of the system that is used to generate data structures describing the tasks and their priorities. This description is most advantageously calculated offline by a “configuration tool” or other program and used to initialize the system when it starts up. Tasks in such an operating system may be activated at any time, but do not start to run until they are the highest-priority runnable task in the system. They continue to run (though they may be pre-empted by other higher-priority tasks at which point a context switch takes place) until their work is done and then terminate. Each task has an entry function that embodies the work the task will carry out.

Each task is described to the configuration tool including its name, priority and entry function. From this the configuration tool constructs a set of data structures for each task that include the priority and the entry function.

The function inside the operating system kernel that manages task switching is called the dispatcher. This is responsible for saving any necessary context, invoking the entry function of the task that is to be activated, and then restoring the previous context when the task terminates.

Applications built using such operating systems typically consist of a plurality of concurrent tasks. The present invention relates to minimizing, or at least reducing, the amount of context that needs to be saved when making a context switch between any two tasks.

Let us consider a conventional operating system that treats all tasks identically when dispatching. It must save any context that may be changed in the task to be dispatched (since it cannot determine what the task itself will be using) and must subsequently restore the context. In a hypothetical operating system, the dispatcher function might look like this:

```
  /* Called with interrupts locked out */
  void OS_Dispatch(void)
  {
  task *t = OS_Find_Highest_Priority_Runnable_Task();
  if (t != OS_Currently_Running_Task()) {
  OS_Save_All_Context();
  set_interrupt_priority(t); /* drop down to task T's IPL */
  if(setjmp(jmp_buf)==0) {
```

t−>entry(); /* Call the task's entry function */

```
  }
  set_interrupt_priority(KERNEL);
  OS_Restore_All_Context();
  }
}
```

Consider what “OS_Save_All_Context” and other dispatcher actions may need to save. A task could:

need space to preserve floating point (fp), Digital Signal Processor (dsp), Memory Management Unit (mmu) or other device context

need space to preserve stack context to allow fast task termination from a function called from its entry point (for example, using a jump_buf structure and setjmp/longjmp calls in C)

need space to store other task-specific data

In other words, a generic dispatcher function will tend to be large and slow, since it needs to be able to deal with any type of task and may need to save and load any number of contexts or resources.

However, it is highly likely that not all tasks will require all the context to be loaded or saved (it can be shown that only when a higher-priority task pre-empts another task that shares access to a particular resource or piece of context must that resource or context be saved in order to preserve the illusion that every task has unrestricted access to all resources).

According to a first aspect of the present invention, there is provided a method of improving operating system efficiency, in which tasks managed by the operating system are organised into a plurality of classes, each class being defined by predetermined task attributes, and wherein a separate dispatcher function is generated for each class.

According to a second aspect of the present invention, there is provided a computing device having an operating system, wherein tasks managed by the operating system are organised into a plurality of classes, each class being defined by predetermined combinations of task attributes, and wherein there is provided a separate dispatcher function for each class.

According to a third aspect of the present invention, there is provided an operating system for a computing device, the operating system managing a plurality of tasks each having various attributes, the tasks being organised into a plurality of classes each defined by a unique combination of task attributes, wherein a separate dispatcher function is provided for each class.

According to a fourth aspect of the present invention, there is provided a configuration tool for use with an operating system managing a plurality of tasks each having various attributes, wherein the configuration tool is operable to organise the tasks into a plurality of classes each defined by a unique combination of task attributes.

Preferably, the tasks are organised into the various classes off-line.

By organising the tasks of the operating system into different classes, each class being uniquely defined by a particular combination of task attributes, it is possible to build up a library of dispatcher functions adapted to the needs of different types of tasks. Accordingly, each dispatcher function maybe streamlined to the particular attributes for improved efficiency, rather than the operating system relying on a generic dispatcher function that needs to be able to deal actively with any task having any particular set of attributes.

Generally, each task will have an associated data structure that describes the task and its attributes. The data structure advantageously contains a reference not only to the entry function of the task (as is usual in existing operating systems), but also to the dispatcher function dedicated to that class of task. This enables each task to be directed to the dispatcher function appropriate to its class.

In some embodiments, there maybe provided a relatively small generic “main” or “head” dispatcher function which can individually call any of a plurality of “sub” dispatcher functions, each dedicated to dispatching tasks having a unique predetermined set of attributes.

Let us consider an example in a system that permits eight classes of task:

| Task Class | Needs “jump_buf” | Needs floating point | Needs DSP |
|---|---|---|---|
| A | N | N | N |
| B | N | N | Y |
| C | N | Y | N |
| D | N | Y | Y |
| B | Y | N | N |
| E | Y | N | Y |
| G | Y | Y | N |
| H | Y | Y | Y |

For each of these classes of task, there will be a separate “sub” dispatcher function. All of these are assumed to operate on a global variable containing a pointer to the task to dispatch.

For example, a “Class C” task that only needs to save and restore floating point context, and does not need to create a jump_buf structure because the task always terminates at the end of its entry function, might have the subdispatcher function:

void Class_C_Dispatch(void)

{

OS_Save_FP_Context();
OS_Set_Interrupt_Priority(t);
OS_Task_To_Dispatch−>entry();

OS_Set_Interrupt_Priority(KERNEL);

OS_Restore_FP_Context();

}

In contrast, a “Class H” task that needs to save and load floating point and DSP context and create a jump_buf structure might have the subdispatcher function:

void Class_H_Dispatch(void)

```
{
    OS_Save_DSP_Context();
    OS_Save_FP_Context();
    OS_Set_Interrupt_Priority(t);
    if(setjmp(jmp_buf)==0) {
```

OS_Task_To_Dispatch−>entry();

```
    }
  OS_Set_Interrupt_Priority(KERNEL);
    OS_Restore_DSP_Context();
    OS_Restore_FP_Context();
}
```

Let us assume that for each task the operating system configuration tool parses a description such as:

TASK t1 CLASS c ENTRY t1_entry PRIORITY 1;

It must therefore output a structure that consists of (at least) the following fields:

typedef struct {

void (*dispatcher)(void);
void (*entry)(void);
int priority;

} Task_control_block;

As an aside, it is to be noted that C syntax is being used for the purposes of illustration. It will, however, be apparent to the skilled reader that it is possible to generate structures in assembly language that can be used interchangeably with those in high-level languages, so the data structure can be generated in any form that has equivalent effect to that described above.

In an operating system adapted to use such a subdispatch mechanism the “main” or “head” dispatcher is modified to call the appropriate subdispatcher for each particular class of task:

```
  /* This is only called from the kernel - so safe to make it static */
  static task *OS_task_to_dispatch
  void OS_Dispatch(void)
  {
  task *t = OS_Find_Highest_Prioty_Runnable_Task();
  if (t != OS_Currently_Running_Task()) {
```

OS_task_to_dispatch = t;

```
  OS_task_to_dispatch−>dispatcher(); /* Call the task's dispatcher
  function */
  }
}
```

A further optimisation, or at least improvement, of this mechanism can be made such that if a task needs no extra context to be loaded or saved, the dispatcher function dedicated to the class of that task can be optimised to be its own entry function.

In the context of the above exposition, this means that “Class A” tasks have their dispatcher function set to be their own entry function—it is possible for the configuration tool to determine statically that some tasks need no extra context and for it to modify the data structures generated for tasks such that they point the “dispatcher” member directly to the entry function.

1. A method of improving operating system efficiency, in which tasks managed by the operating system are organised into a plurality of classes, each class being defined by predetermined task attributes, and wherein a separate dispatcher function is generated for each class.

2. A method according to claim 1, wherein a main dispatcher function calls the separate dispatcher functions as required.

3. A method according to claim 1, wherein the attributes are selected from a non-exhaustive group including: need to save floating point context, need to save digital signal processor context and need to save memory management unit context.

4. A method according to claim 1, wherein the tasks are organised into classes off-line by a configuration tool.

5. A method according to claim 1, wherein each task has an associated data structure that describes the task and its attributes, and wherein the data structure includes a reference to the dispatcher function appropriate to the class of the task.

6. A method according to claim 1, wherein each task has an entry function that performs work that the task is to carry out, and wherein, if it is determined that a task requires no extra context to be loaded or saved, the dispatcher function for the class of that task is used as the entry function for that task.

7. A computing device having an operating system, wherein tasks managed by the operating system are organised into a plurality of classes, each class being defined by predetermined combinations of task attributes, and wherein there is provided a separate dispatcher function for each class.

8. A device as claimed in claim 7, wherein a main dispatcher function is provided, the main dispatcher function being adapted to call the separate dispatcher functions as required.

9. A device as claimed in claim 7, wherein the attributes are selected from a non-exhaustive group including: need to save floating point context, need to save digital signal processor context and need to save memory management unit context.

10. A device as claimed in claim 7,- further comprising a configuration tool adapted to organise the tasks into classes off-line.

11. A device as claimed in claim 7, wherein each task has an associated data structure that describes the task and its attributes, and wherein the data structure includes a reference to the dispatcher function appropriate to the class of the task.

12. A device as claimed in claim 7, wherein each task has an entry function that performs work that the task is to carry out, and wherein, if it is determined that a task requires no extra context to be loaded or saved, the dispatcher function for the class of that task is used as the entry function for that task.

13. An operating system for a computing device, the operating system managing a plurality of tasks each having various attributes, the tasks being organised into a plurality of classes each defined by a unique combination of task attributes, wherein a separate dispatcher function is provided for each class.

14. An operating system as claimed in claim 13, wherein a main dispatcher function is provided, the main dispatcher function being adapted to call the separate dispatcher functions as required.

15. An operating system as claimed in claim 13, wherein the attributes are selected from a non-exhaustive group including: need to save floating point context, need to save digital signal processor context and need to save memory management unit context.

16. An operating system as claimed in claim 13, farther comprising a configuration tool adapted to organise the tasks into classes off-line.

17. An operating system as claimed in claim 13, wherein each task has an associated data structure that describes the task and its attributes, and wherein the data structure includes a reference to the dispatcher function appropriate to the class of the task.

18. An operating system as claimed in claim 13, wherein each task has an entry function that performs work that the task is to carry out, and wherein, if it is determined that a task requires no extra context to be loaded or saved, the dispatcher function for the class of that task is used as the entry function for that task.

19. A configuration tool for use with an operating system managing a plurality of tasks each having various attributes, wherein the configuration tool is operable to organise the tasks into a plurality of classes each defined by a unique combination of task attributes.

20. A tool as claimed in claim 19, wherein the attributes are selected from a non-exhaustive group including: need to save floating point context, need to save digital signal processor context and need to save memory management unit context.

21. A tool as claimed in claim 19, the tool being adapted to organise the tasks into classes off-line.
